(19) United States
(12) Patent Application Publication
(10) Pub. No.: US 2016/0370837 A1
(43) Pub. Date: Dec. 22, 2016

(54) FIRST DROOP EVENT MITIGATION BY CLOCK GENERATION FREQUENCY STAGGERING FOR CORE POWER DELIVERY

(71) Applicant: Samsung Electronics Co., Ltd., Suwon-si (KR)

(72) Inventors: Jin SHI, Foster City, CA (US); Jawad NASRULLAH, Palo Alto, CA (US)

(21) Appl. No.: 14/742,680

(22) Filed: Jun. 17, 2015

(51) Int. Cl. G06F 1/32

(52) U.S. Cl. CPC G06F 1/324; G06F 1/3296

(57) ABSTRACT

A first droop mitigation methodology in which the clock frequency applied to a processor's core is reduced from its normal operating value when a droop event capable of causing the first droop in the voltage being delivered to the core is anticipated. The reduced core switching frequency reduces the average core current, thereby mitigating the first droop. The reduced frequency is then gradually increased back to its normal operating value through a multi-step frequency ramp, instead of one fixed step. A pre-determined delay may be applied prior to each frequency increase step. A clock generator in the processor die may be configured to perform such frequency staggering in response to a droop event signal, which may be generated by the operating system or other program code being executed by the processor. The frequency staggering-based first droop mitigation may be predominantly software-based, and can be applied to core power delivery.

### TECHNICAL FIELD

The present disclosure generally relates to mitigation of first droop in power delivery. More specifically, and not by way of limitation, particular embodiments of the inventive aspects disclosed in the present disclosure are directed to gradually increasing the core switching frequency through a multi-step frequency ramp to reduce first droop in the power delivery to a processing core.

### BACKGROUND

Modern integrated circuits, such as microprocessors, are designed and implemented to operate at a determined set of supply voltage. As more functions are integrated in a single high performance integrated circuit (or a “chip”), the on-chip noise condition due to switching activity on the chip may pose new challenges. Power supply and power distribution system noise, especially voltage dips (or droops) due to large step current increases, is a limiting factor in how fast the circuits in a processor can operate. For example, higher operating frequencies require the logic circuits in the processor's core to operate at a faster rate, which may be achieved if the processor is operating at a higher supply voltage. However, using a supply voltage that is lower than the required level may cause timing failures or other erroneous operations of the processor core. Voltage droops in the power distribution network of a processor may put processor's internal core circuits at risk of falling outside of their operational limits.

A voltage droop is a loss or dip in the power supply voltage as the power supply tries to drive a circuit load. For example, power consuming executions in a microprocessor may result in voltage droops because of the resulting step current change presented to the associated Power Delivery/Distribution Network (PDN). A higher current consumption by the processor's core may result in corresponding voltage droops in the PDN. Traditionally, decoupling capacitors (also referred to as “decap”) have been used to limit the magnitude of such voltage droops. However, as design frequencies have risen, decoupling capacitors are becoming either less effective at such higher operational frequencies or too costly to implement for desired effect.

Furthermore, depending on the program code or software instructions being executed, the power requirements of a processor can vary drastically. For example, the software code may cause occasional spikes in processing activity, which may result in a sudden increase in the power needed by the processor. These significant and sudden changes in drawn power may cause substantial droops (and overshoots) in the supplied voltage, even though the power supply is providing the rated voltage needed for the processor to operate at the desired frequency.

### SUMMARY

In one embodiment, the present disclosure is directed to a method that comprises: (i) receiving a droop event signal at a processor, wherein the droop event signal anticipates a switching activity that is to be performed by a core logic in the processor and that is capable of causing a first droop in voltage being delivered to the core logic; (ii) in response to the droop event signal, reducing frequency of a clock signal being supplied to the core logic to a first frequency value; and (iii) gradually increasing the frequency of the clock signal from the first frequency value to a final frequency value through multiple steps.

In another embodiment, the present disclosure is directed to a processor that comprises: (i) a core logic to process a program code; and (ii) a clock generator to supply a clock signal to the core logic. The clock generator is operative to receive a droop event signal from the program code. The droop event signal anticipates a switching activity that is to be performed by the core logic and that is capable of causing a first droop in voltage being delivered to the core logic. The clock generator is also operative to: (a) reduce frequency of the clock signal to a first frequency value in response to the droop event signal, and (b) gradually increase the frequency of the clock signal from the first frequency value to a final frequency value through multiple steps.

In a further embodiment, the present disclosure is directed to a system, which comprises: a power supply unit; and a processor coupled to the power supply unit. In the system, the processor includes: a core logic to process a program code; and a clock generator to supply a clock signal to the core logic. The clock generator in the processor is operative to: (i) receive a droop event signal from the program code, wherein the droop event signal anticipates a switching activity that is to be performed by the core logic and that is capable of causing a first droop in voltage being delivered to the core logic by the power supply unit; (ii) reduce frequency of the clock signal to a first frequency value in response to the droop event signal; and (iii) gradually increase the frequency of the clock signal from the first frequency value to a final frequency value through multiple steps.

### BRIEF DESCRIPTION OF THE DRAWINGS

In the following section, the inventive aspects of the present disclosure will be described with reference to exemplary embodiments illustrated in the figures, in which:

FIG. 1 shows an exemplary system in which the first droop mitigation methodology according to one embodiment of the present disclosure may be implemented;

FIG. 2 illustrates a lumped model of a typical power delivery/distribution network from the VRM to the processor in the exemplary system of FIG. 1;

FIG. 3 depicts an exemplary plot of the first droop in the die voltage being supplied to the processor core in the embodiments of FIGS. 1-2;

FIG. 4 is an exemplary table containing simulation results that show correlation between core switching frequency and the average of the core current Icc(t) according to one embodiment of the present disclosure;

FIG. 5 is an exemplary table containing simulation results that provide comparison of first droop with average Icc(t) at different core frequencies according to one embodiment of the present disclosure;

FIG. 6 depicts an exemplary flowchart of the frequency staggering-based first droop mitigation methodology according to one embodiment of the present disclosure;

FIG. 7 is an exemplary illustration of the multi-step staggering of the core switching frequency according to one embodiment of the present disclosure;

FIG. 8 illustrates an exemplary table containing simulation results that show the impact of fₘₐₓ delay and the number of frequency staggering steps on first droop mitigation according to one embodiment of the present disclosure;

FIG. 9 shows an exemplary architecture of a Clock Generation with Frequency Staggering (CGFS) based first droop mitigation mechanism according to one embodiment of the present disclosure;

FIG. 10 is a flowchart for CGFS-based first droop mitigation using the architecture 110 of the embodiment in FIG. 9;

FIG. 11 depicts a more detailed layout of the system in FIG. 1 according to one embodiment of the present disclosure.

### DETAILED DESCRIPTION

In the following detailed description, numerous specific details are set forth in order to provide a thorough understanding of the disclosure. However, it will be understood by those skilled in the art that the disclosed inventive aspects may be practiced without these specific details. In other instances, well-known methods, procedures, components and circuits have not been described in detail so as not to obscure the present disclosure. Additionally, the described inventive aspects can be implemented to perform first droop mitigation in any semiconductor-based system, including, for example, semiconductor memories, processors, memory controllers, and the like.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “pre-determined,” “time-wise”, “CGFS-based,” etc.) may be occasionally interchangeably used with its non-hyphenated version (e.g., “predetermined,” “timewise”, “CGFS based,” etc.), and a capitalized entry (e.g., “Voltage Regulator Module,” “Power Delivery Network,” etc.) may be interchangeably used with its non-capitalized version (e.g., “voltage regulator module,” “power delivery network,” etc.). Such occasional interchangeable uses shall not be considered inconsistent with each other.

It is noted at the outset that the terms “coupled,” “operatively coupled,” “connected”, “connecting,” “electrically connected,” etc., are used interchangeably herein to generally refer to the condition of being electrically/electronically connected in an operative manner. It is further noted that various figures (including component diagrams) shown and discussed herein are for illustrative purpose only, and are not drawn to scale.

Except for the term “first droop,” the terms “first,” “second,” etc., as used herein, are used as labels for nouns that they precede, and do not imply any type of ordering (e.g., spatial, temporal, logical, etc.) unless explicitly defined as such.

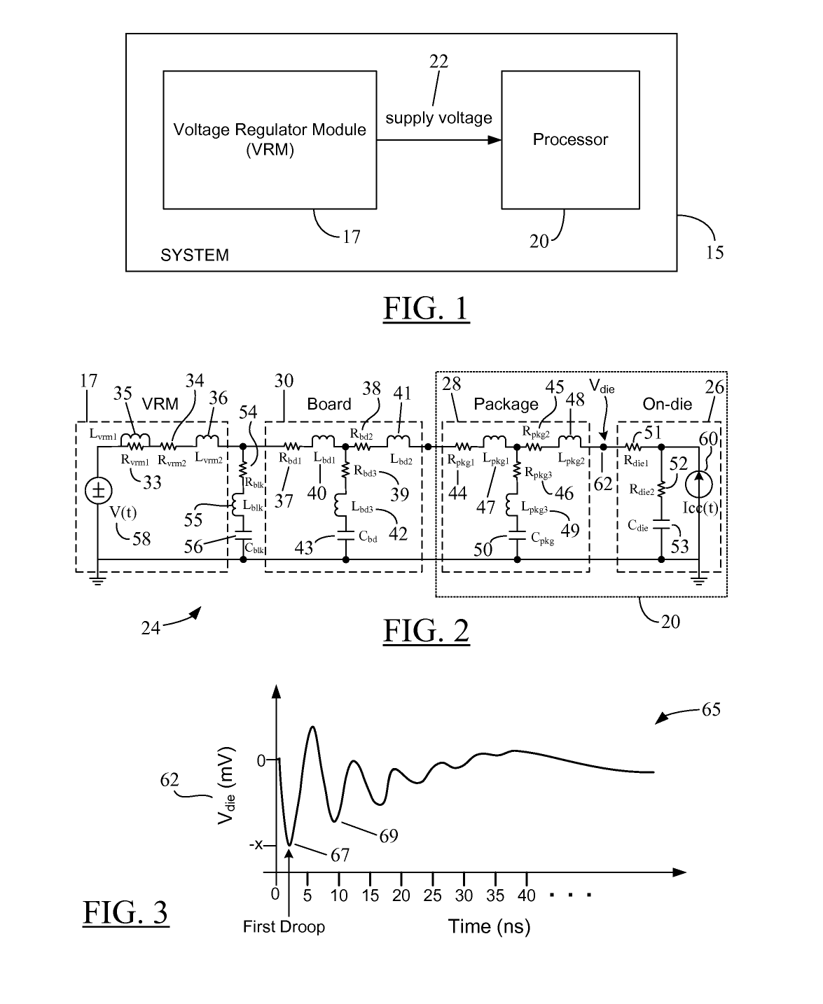

FIG. 1 shows an exemplary system 15 in which the first droop mitigation methodology according to one embodiment of the present disclosure may be implemented. For ease of illustration and discussion, only a portion of the system 15 is shown in FIG. 1. Additional components of the exemplary system 15 are illustrated in the embodiment of FIG. 11, which is described later below. As shown in FIG. 1, the system 15 may include a Voltage Regulator Module (VRM) 17 and a processor 20. The VRM 17 may supply regulated power to the processor 20. For example, the VRM 15 may supply a regulated input voltage—indicated as a supply voltage 22 in FIG. 1—to the processor 20. In particular embodiments, the VRM 17 may be controllable to supply power to processor 120 at a number of different voltage levels. For example, the processor 20 may be configured to operate at a number of different frequencies, each of which may require a different input voltage. In that regard, the processor 20 may control the VRM 17 to supply the necessary voltage level for proper operation of the processor.

It is understood that in certain embodiments, the system 15 may include many such processors 20, and the VRM 17 may supply regulated power to such processors and other circuit components (not shown).

It is noted here that the term “power” is primarily used herein as referring to delivery of a “voltage.” Thus, in the context of the first droop related discussion herein, the terms “power” and “voltage” may be considered to be interchangeably used.

The system 15 may be, for example, a computer system (desktop or laptop), a tablet computer, a mobile device, a cellular phone or other User Equipment (UE), a video gaming unit or console, a machine-to-machine (M2M) communication unit, a stateless “thin” client system, or any other type of computing or data processing device.

The processor 20 may be any Integrated Circuit (IC) or chip capable of performing a processing operation such as, for example, processing of data, processing of control signals, and/or execution of instructions (e.g., in a program code). The processor 20 may be, for example, a Central Processing Unit (CPU), a microprocessor, an Arithmetic Logic Unit (ALU), a Graphics Processing Unit (GPU), a memory controller, a peripheral interface controller such as a Peripheral Component Interconnect Express (PCIe) root complex or switch, or any other processing device. In one embodiment, the processor 20 may be a synchronous device that operates based on one or more clock signals. The processor 20 may be configured to operate within a range of potential clock frequencies. Generally, higher clock frequencies may cause the logic circuits (not shown) in the processor 20 to operate at a faster rate, which may require a higher level of supply voltage 22 or continued maintenance of the currently-supplied voltage level. These logic circuits may comprise one or more cores of the processor 20. For ease of discussion, however, these logic circuits are collectively and interchangeably referred to herein as a processor “core” or “cores.”

In one embodiment, the processing throughput and power/voltage load of the processor 20 at any particular time may be influenced by the software code currently being executed by the processor 20. For example, the program code or software instructions may cause occasional spikes in processing activity, which may require a sudden increase in the power needed by the processor 20 or, at the very least, prevention/mitigation of any drop in the operating voltage level of the logic circuitry forming the processing core. As discussed below, the first droop event may result in reduction of the supply voltage 22 being delivered to the processor core. Providing a lower voltage than the required level to the processor core can potentially cause timing failures and, consequently, erroneous operation of the processor 20.

FIG. 2 illustrates a lumped model of a typical power delivery/distribution network (PDN) 24 from the VRM 17 to the processor 20 in the exemplary system 15 of FIG. 1. As shown in FIG. 2, it is understood that the processor 20 generally includes a semiconductor core portion (or the processor die) 26 that is encapsulated within a package 28. The core portion or die 26 may include one or more processor cores, which contain the logic circuits that enable the processor 20 to perform its processing functionality. A “core,” for example, may comprise a processor's CPU and associated cache. Thus, more generally, a processor “core” is the functional block that actually performs the instruction executions to enable the processor to provide the requisite processing functionality. On the other hand, a processor's “die” may include core as well as ancillary non-core components such as, for example, clock generator(s), interface circuits, bus driver(s), and the like. However, because a processor is primarily “defined” by its core because it is the core that essentially performs the processing functionality and because the effect of the first droop are more pronounced on the operations of a processor's core, for ease of discussion, the terms “core” and “die” may be used interchangeably herein despite presence of such non-core components on a typical processor die. Although not shown in FIG. 1, in one embodiment, the processor 20 and the VRM 17 may be mounted on a printed circuit board (PCB), which may be a motherboard 30 as shown in FIG. 2. Thus, the PDN 24 may include the VRM 17 the motherboard portion 30, the processor package 28, and the processor core portion 26—all of which are shown using dashed lines in FIG. 2.

In the lumped model of FIG. 2, the VRM 17 the motherboard 30, the package 28, and the die 26 may include a number of parasitics, which are shown as resistors, inductors, and capacitors between the VRM 17 and the processor die 26. Thus, as shown in FIG. 2, for example, the VRM 17 may be modeled as including resistors 33-34 (Rᵥₘ₁ and R_{vm2,} respectively) and inductors 35-36 (Lᵥₘ₁ and Lᵥₘ₂, respectively); the motherboard 30 may be modeled as including resistors 37-39 (R_{bd1} through Rb_{bd3,} respectively), inductors 40-42 (L_{bd1} through L_{bd3}, respectively), and an on-board decoupling capacitor (decap) 43 (C_{bd}); the package 28 may be modeled as including resistors 44-46 (R_{pkg1} through R_{pkg3}, respectively), inductors 47-49 (L_{pkg1} through L_{pkg3}, respectively), and an on-package decap 50 (C_{pkg}); and the processor core/die 26 may be modeled as including resistors 51-52 (R_{die1} and R_{die2}, respectively) and an on-die decap 53 (C_{die}). Additionally, the lumped model in FIG. 2 also may include a bulk resistor 54 (R_{blk}), a bulk inductor 55 (L_{blk}), and a bulk decap 56 (C_{blk}) representing the R-L-C parasitics of the bulk portion of the PDN between the VRM 17 and the motherboard 30. In one embodiment, the VRM 17 may include a voltage source V(t) 58 as shown in FIG. 2. In another embodiment, the voltage source 58 may be a part of the system 15, but may not be a part of the VRM 17. In this case, the voltage source 58 may supply the power to the processor 20 through the VRM 17. In the embodiment of FIG. 2, the operational current (Icc(t)) flowing through the processor core is modeled as a current source 60.

As mentioned earlier, certain processing activities such as, for example, program instructions causing sudden spikes in data processing, or activities requiring sudden increase in the processing clock frequency, may affect the level of the voltage being applied to the processor core 26. Such voltage is represented as V_{die} 62 in FIG. 2. Generally, the parasitics 33-56, in conjunction with sudden changes in the current (Icc(t)) drawn by the processor core 26 from the VRM 17—for example, as part of increased processing activity by the logic circuits in the core 26—can result in significant droops and overshoots in the voltage 62 (V_{die}) being provided to the processor core 26, even when the VRM 17 may be providing the rated voltage needed for the processor 20 to operate at the desired frequency.

FIG. 3 depicts an exemplary plot 65 of the first droop 67 in the die voltage 62 (V_{die}) being supplied to the processor core 26 in the embodiments of FIGS. 1-2. In FIG. 3, the die voltage 62 in millivolts (mV) is plotted against time (in nanoseconds). As noted before, in one embodiment, the first droop 67 may occur in response to a sudden increase in the activity of the processor 20. A sudden spike in the processor activity or a switching activity at a high clock frequency may increase the rate of change of current (a “di/dt event”) for Icc(t) 60, thereby causing a sudden drop in the die voltage 62. This drop due is generally referred to as the “first droop,” and the di/dt event is a factor affecting the occurrence of the first droop. Thus, in response to a spike in processing activity, the supply voltage 22 being delivered to the processor 20 may exhibit transient fluctuations as shown in FIG. 3. In particular, the first droop 67 may be followed by a second droop 69, occasional overshoots, and the like, as shown in FIG. 3. If the average operating voltage is indicated as representing a zero (0) level, then the first droop 67 may have a negative value as indicated by the “−x” parameter on the y-axis in FIG. 3. As mentioned before, the sudden, transient drop in the supply voltage (the first droop) can be catastrophic to the operation of the processor 20.

More generally, the first droop 67 may be caused by the die/package resonance, which is typically in the middle frequency range of around 100 MHz. The first droop 67 may be proportional to the total inductance (L_{pkg}) of the processor's package 28, inversely proportional to the on-die and package decoupling capacitors (decaps) 53 (C_{die}), 50 (C_{pkg}), respectively, and proportional to the anti-resonance quality factor (which may be represented as the ratio L_{pkg}/R_{pkg}). The first droop 67 also may be proportional to the average of the Icc(t) current 60 injected into the PDN 24 due to a switching activity (the di/dt event). Thus, reducing inductance of the package 28, increasing the on-die/package decaps, power gating, decreasing the quality factor by inserting a serial high resistance in the on-die power/ground network, and activity staggering are general approaches to reduce the first droop 67 due to the di/dt event. However, activity staggering may be only applied to power delivery to the non-core components (not shown) in the system 15. Such non-core components may include, for example, a memory unit, a Serializer/Deserializer (SerDes) interface for the processor 20, a peripheral unit, and the like. It may be difficult to apply the activity-staggering approach for power delivery to the processor core 26. Furthermore, reducing package inductance and/or increasing the on-die/package decaps may each increase design cost. Therefore, as discussed in more detail below, the Clock Generation Frequency Staggering (CGFS) based first droop mitigation approach according to teachings of particular embodiments of the present disclosure provides an alternative solution for core power delivery. In the CGFS methodology, the core switching frequency is gradually increased through a multi-step frequency ramp, instead of in one fixed frequency step. Furthermore, the CGFS approach may be implemented in software at low cost, and can be applied to core power delivery.

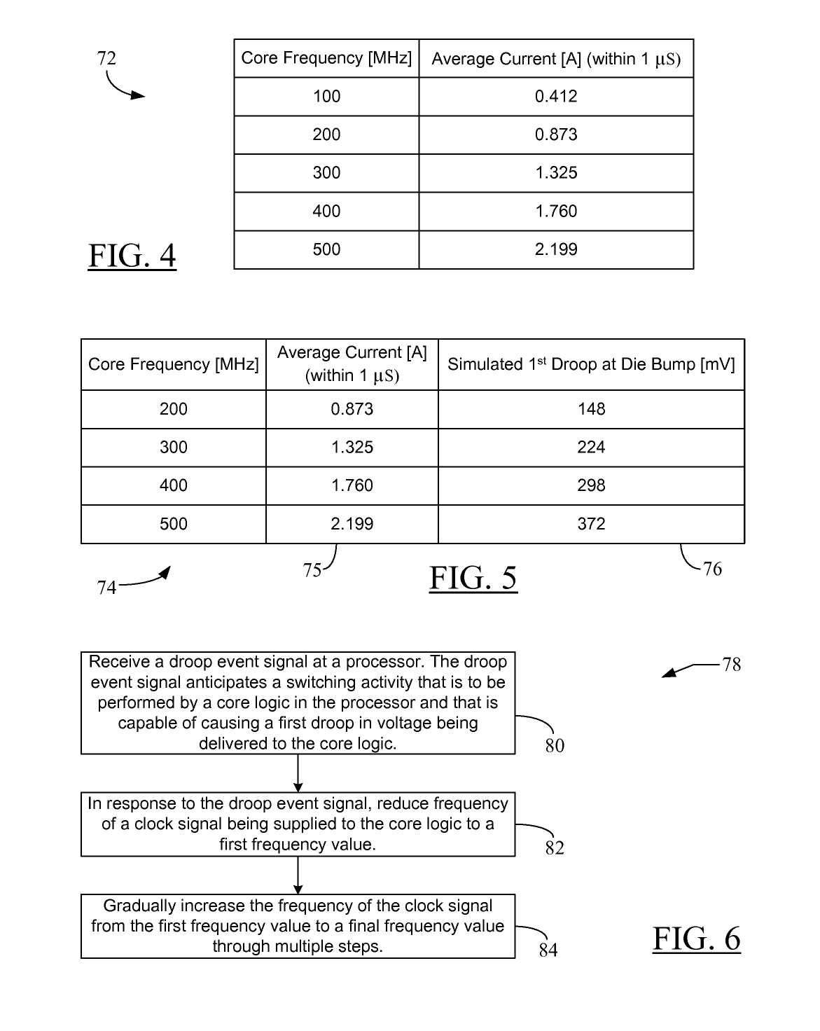

FIG. 4 is an exemplary table 72 containing simulation results that show correlation between core switching frequency (in MHz) and the average of the core current Icc(t) 60 according to one embodiment of the present disclosure. The system level PDN 24 was simulated as part of observation of the first droop 67. The core switching frequency is the clock frequency applied to the processor core 26, and the average core current (in amperes, A) was measured within one microsecond (1 μs) of application of the corresponding clock frequency to the processor core. The average or Direct Current (DC) component (0^{th} harmonic) of the core current Icc(t) over a period “T” (here, approximately 1 μs or less) may be given by:

$${I}_{ave} = \frac{1}{T} {\int }_{T} Icc ( t ) d t$$

It is noted here that Icc(t) may have a much larger current swing than its average. For example, at 500 MHz clock frequency, the average of Icc(t) over 300 ns was observed to be approximately 2.199 A, whereas the actual Icc(t) signal during this period had the highest current swing of up to approximately 19.412 A and the negative current swing of approximately −0.996 A.

Referring to FIG. 4, it is observed from the results in table 72 that the average current of Icc(t) 60 during a di/dt event related to the first droop is roughly proportional to the core switching frequency. The di/dt event resulting in the first droop may be less than 10 ns in duration.

FIG. 5 is an exemplary table 74 containing simulation results that provide comparison of first droop with average Icc(t) at different core frequencies according to one embodiment of the present disclosure. The frequency-specific average Icc(t) values are given in column 75, whereas corresponding first droop voltage levels are given in column 76. FIG. 5 is a continuation of FIG. 4, with an additional column 76 providing simulated voltage values (in mV) for the first droop at die bump—i.e., the first droop measured at location 62 in the PDN 24. For ease of discussion, the voltage values for the first droop are noted as positive values. However, as shown in FIG. 3, it is understood that the first droop voltage level is below (or in negative direction) the voltage level of the operating voltage of the processor core before occurrence of the first droop. Thus, for example, the first droop voltage of 148 mV in table 74 indicates that the operating voltage drops by 148 mV to produce the first droop voltage level at clock frequency of 200 MHz, and so on.

During the simulation associated with FIGS. 4-5, it was observed that an ideal step current load can represent a “noisy” step current load (i.e., an actual Icc(t)) beyond 100+ MHz, which is greater than the die/package resonance frequency. Therefore, this ideal DC current, which equals the average of Icc(t)—some values of which are shown, for example, in column 75 in FIG. 5, can be used to replace actual Icc(t) for first droop simulation.

From the table 74 in FIG. 5, it is observed that the average of the Icc(t) may be a dominant contributor to the first droop. In other words, the first droop may be proportional to the average current injected into the PDN 24 due to a switching activity (the di/dt event). Therefore, limiting the average current may help mitigate the severity of the first droop. Furthermore, as discussed with reference to FIG. 4, the average current of Icc(t) may be roughly proportional to the core switching frequency. Therefore, instead of activity staggering, in particular embodiments, the di/dt event may be controlled by gradually increasing the core switching frequency through a multi-step ramp, which will in turn control the average current injected into the PDN, thereby mitigating the first droop. In this manner, frequency staggering (which is discussed in more detail below) may be used for first droop mitigation in the context of core power delivery.

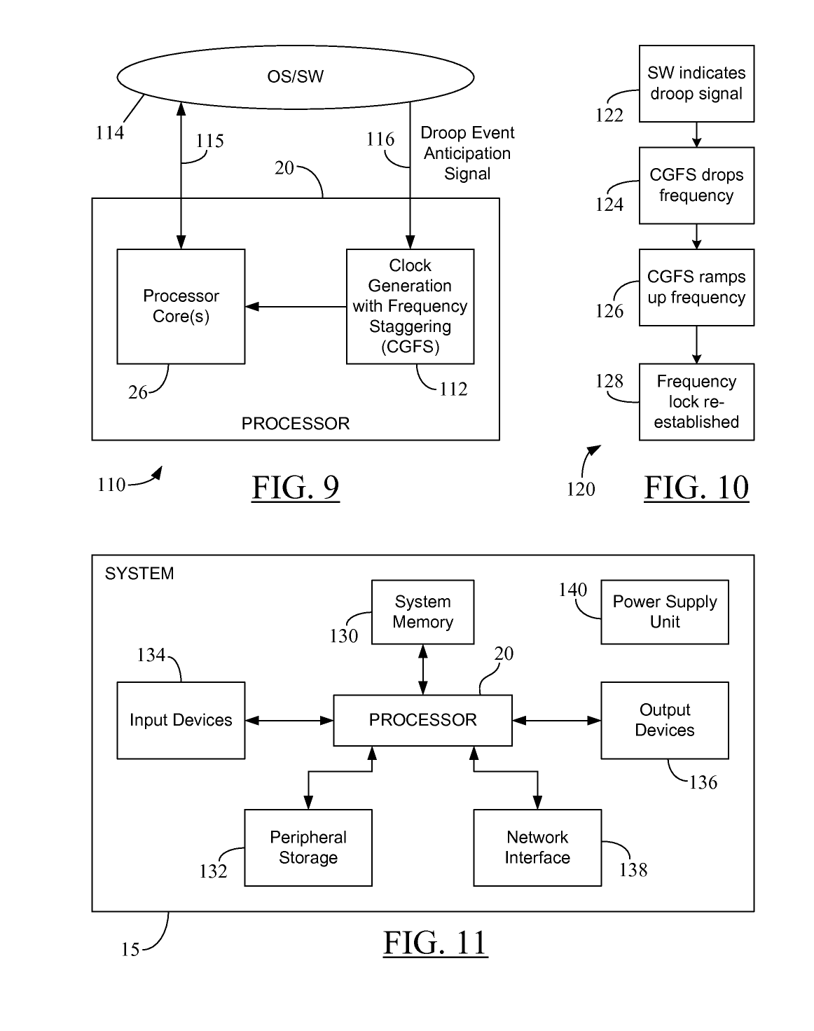

FIG. 6 depicts an exemplary flowchart 78 of the frequency staggering-based first droop mitigation methodology according to one embodiment of the present disclosure. As indicated at block 80, a droop event signal may be received at a processor, such as, for example, the processor 20 in FIG. 1. The droop event signal may anticipate a switching activity that is to be performed by a core logic in the processor and that is capable of causing a first droop in the voltage being delivered to the core logic. In one embodiment, the die or core 26 in FIG. 2 may represent such core logic. In response to the droop event signal, the frequency of a clock signal being supplied to the core logic may be reduced to a first frequency value (block 82) to mitigate the first droop in the voltage being delivered to the core logic. Thereafter, the frequency of the clock signal may be gradually increased from the first frequency value to a final frequency value through multiple steps (block 84). In one embodiment, the steps outlined in the flowchart 78 of FIG. 6 may be performed by a clock generator in a processor's die, as discussed later with reference to the exemplary embodiment of FIG. 9.

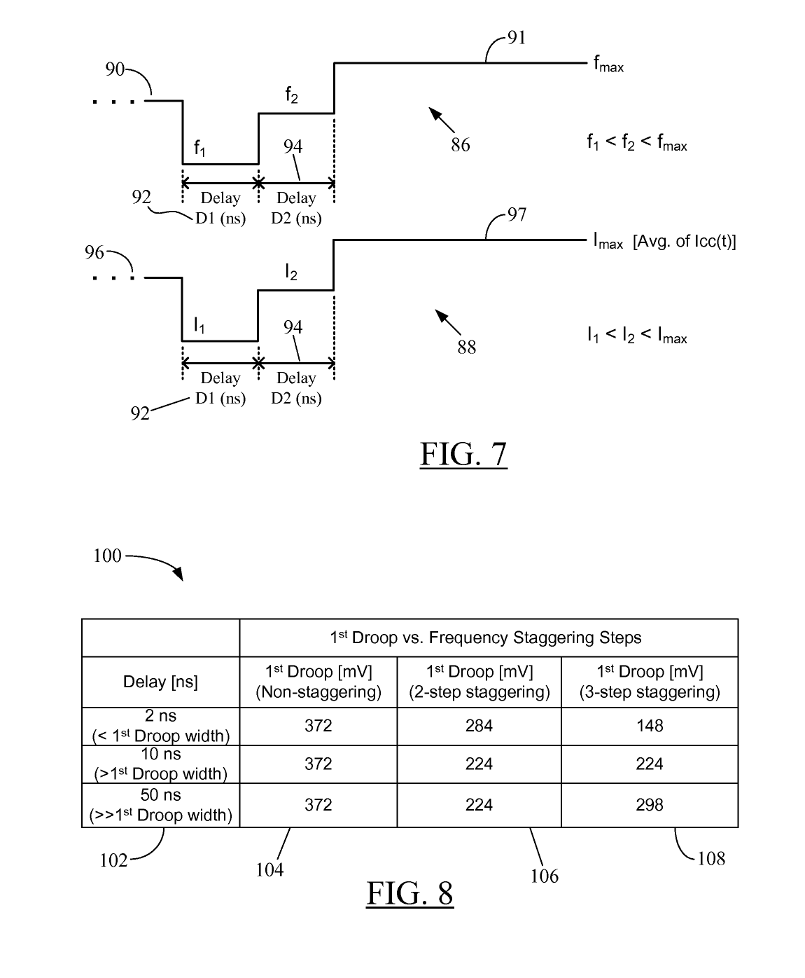

FIG. 6 provides an exemplary outline of the core switching frequency staggering methodology according to the teachings of the present disclosure. Additional details of this methodology are discussed below with reference to FIGS. 7-10.

FIG. 7 is an exemplary illustration of the multi-step staggering of the core switching frequency according to one embodiment of the present disclosure. Two plots 86, 88 are shown in FIG. 7—(i) the first plot 86 illustrates multi-step staggering of the clock frequency being supplied to a processor core, such as, for example, the core 26 in FIG. 2, and (ii) the second plot 88 illustrates a corresponding multi-step staggering of the average Icc(t) resulting from the staggering of the core switching frequency. When a droop event is anticipated—such as, for example, when a droop event signal is received at the processor 20 as discussed below with reference to FIG. 9—the current operating frequency of the processor core may be reduced to a first frequency value (f₁). In the exemplary illustration of FIG. 7, the current clock frequency is identified by reference numeral “90.” It is noted that the current clock frequency 90 may have any value. The frequency value 90 is shown less than the fₘₐₓ level 91 for illustration only. In one embodiment, the frequency value 90 may be the final frequency value “fₘₐₓ”—i.e., the frequency of the clock signal prior to reception of the droop event signal may be the same as the final frequency value fₘₐₓ in the multi-step frequency staggering. The droop event signal may be generated by software (as discussed later with reference to FIG. 9) in anticipation of a switching activity that is to be performed by the processor's core and that is capable of causing the first droop in the voltage being delivered to the processor core if the switching activity is performed at a high clock frequency.

As shown in FIG. 7, in one embodiment, the first frequency value (f₁) may be gradually increased to the final frequency value (fₘₐₓ) through multiple steps using a pre-determined time delay prior to each frequency increase step. For example, as shown in FIG. 7, the core switching frequency may be initially reduced to and maintained at the first frequency value (f₁) until a first time delay (D1) 92 has elapsed. After the time delay D1, the core switching frequency may be increased to a second frequency value (f₂) and maintained at that level until a second time delay (D2) 94 has elapsed. After the time delay D2, the core's clock frequency may be eventually increased to the final operating frequency value (fₘₐₓ). Thus, in the three-step frequency staggering approach (from f₁ to f₂ to fₘₐₓ) illustrated in FIG. 7, f₁<f₂<fₘₐₓ. As noted before, fₘₐₓ may be the operating frequency of the core—which is indicated by level “90” in FIG. 7—immediately prior to its reduction to f₁ to mitigate the first droop in an upcoming droop event. The time delays D1 and D2 may be defined in nanoseconds (ns). In one embodiment, the time delay between each frequency step may be identical—i.e., D1=D2.

The delayed switching of the core clock frequency from f₁ to fₘₐₓ may limit the di/dt of the average of the core current Icc(t), thereby mitigating the first droop. For example, the plot 88 in FIG. 7 shows the average core current (i.e., average of Icc(t)) corresponding to and resulting from the multi-step frequency staggering in plot 86. This average core current may be referred to as “Iₐᵥₑ” in the discussion herein. As shown, the average core current may be at level 96 prior to its reduction to level I₁ corresponding to the reduced core switching frequency f₁. It is noted that the pre-reduction average current level 96 may have any value. The Iₐᵥₑ level 96 is shown less than the Iₘₐₓ level 97 for illustration only. In one embodiment, the level 96 may be the same as the level 97—i.e., the average Icc(t) (i.e., Iₐᵥₑ) prior to reception of the droop event signal may be the same as the final value Iₘₐₓ in the multi-step frequency staggering.

As shown in FIG. 7, as the first frequency value (f₁) is gradually increased to the final frequency value (fₘₐₓ) through multiple steps, a similar increase in the value of Iₐᵥₑ takes place. For example, as shown in FIG. 7, Iₐᵥₑ may be initially reduced to and maintained at a first current level (I₁) until a first time delay (D1) 92 has elapsed. After the time delay D1, as the core switching frequency is increased to the second frequency value (f₂), the average current lave also increases to a second current level (I₂) and remains at that level until the second time delay (D2) 94 has elapsed. After the time delay D2, the core's clock frequency reaches the final operating frequency value (fₘₐₓ), and, in response, Iₐᵥₑ reaches the Imax level 97. Thus, in the three-step frequency staggering approach illustrated in FIG. 7, I₁<I₂<Iₘₐₓ. In one embodiment, f₁=200 MHz, f₂=300 MHz, and fₘₐₓ=500 MHz, and corresponding values for Iₐᵥₑ are: I₁=0.873A, I₂=1.325A, and Iₘₐₓ=2.199A, which are also shown in the tables 72 and 74 in FIGS. 4 and 5, respectively.

More generally, f₁=a*fₘₐₓ (0<a<1), f₂=*fₘₐₓ (0<b <1), I₁=p*Iₘₐₓ (0 <p<1), and I₂=q*Iₘₐₓ (0 <q <1). As noted before, fₘₐₓ may be the typical clock frequency at which the processor core normally operates, and Iₘₐₓ may be the average core current corresponding to fₘₐₓ.

FIG. 8 illustrates an exemplary table 100 containing simulation results that show the impact of fₘₐₓ delay and the number of frequency staggering steps on first droop mitigation according to one embodiment of the present disclosure. In the discussion herein, FIG. 8 is described in the context of the plot 86 in FIG. 7. Furthermore, in the embodiment of FIG. 8, it is assumed that the first delay 92 (D1)=the second delay 94 (D2), wherever applicable. The first column 102 in the table 100 lists different delay values (in ns), the second column 104 provides the first droop voltage level when no frequency staggering is employed, the third column 106 provides the first droop voltage level when a two-step frequency staggering is employed, and the final column 108 provides the first droop voltage level when a three-step frequency staggering is employed.

As noted earlier, the first droop may be caused by die/package resonance, which typically occurs around 100 MHz. Therefore, as shown in FIG. 3, in one embodiment, the width of the first droop may be in the range of 3.5 to 4 ns. Thus, the first delay value of approximately 2 ns in column 102 represents a delay that is less than the width of the first droop, the second delay value of approximately 10 ns in column 102 represents a delay that is more than the width of the first droop, and the third delay value of approximately 50 ns in column 102 represents a delay that is significantly greater than the width of the first droop.

The column 104 in FIG. 8 relates to a non-staggering approach, in which the core switching frequency is not changed regardless of the droop event signal. In one embodiment, the core switching frequency is maintained at fₘₐₓ=500 MHz regardless of the droop event. In the context of FIG. 7, such an approach would result in a straight line connecting levels 90 and 91, and there will be no f₁ and f₂. In that regard, the delay values in column 102 are not relevant to the non-staggering approach of column 104.

In the 2-step staggering approach of column 106, the intermediate frequency f₂ and associated delay D2 are absent. In other words, the clock frequency is switched directly from f₁ to fₘₐₓ after the delay D1—the values of which are provided in column 102. In the 2-step staggering approach of column 106, the clock frequency values are: f₁=300 MHz, and fₘₐₓ=500 MHz.

Finally, the 3-step staggering approach of column 108 is similar to the frequency staggering illustrated in FIG. 7. Thus, in case of column 108, the frequency values are: f₁=200 MHz, f₂=300 MHz, and fₘₐₓ=500 MHz; and the delay values are: D1=D2=2 ns, 10 ns, and 50 ns, as applicable.

In one embodiment, the value of f₁—i.e., the clock frequency to which the current clock frequency may be reduced in anticipation of a droop event—may be pre-determined or pre-defined. For example, a clock generator in the processor, such as the clock generator 112 in FIG. 9, may be configured in hardware and/or software to reduce a core's current operating frequency to a pre-determined value, f₁. Furthermore, in another embodiment, the value of f₁ may be less than half of the final frequency value fₘₐₓ to significantly limit the average core current for first droop mitigation.

It is observed from the simulation results in table 100 that, in the context of 2-step triggering, if fₘₐₓ is delayed for approximately 10 ns (i.e., more than the width of the first droop), the peak value of the first droop may reduce by approximately 40% over the first droop value in case of the non-staggering approach [(372-224)/372*100=39.8%≈40%]. In case of 3-step triggering, that reduction is increased to approximately 60% R372-148)/372*100=60.2%1. On the other hand, the fₘₐₓ delay of more than 10 ns may not have more significant effect on the first droop mitigation.

FIG. 9 shows an exemplary architecture 110 of a Clock Generation with Frequency Staggering (CGFS) based first droop mitigation mechanism according to one embodiment of the present disclosure. The discussion of FIG. 9 is provided in the context of FIG. 10, which is a flowchart 120 for CGFS-based first droop mitigation using the architecture 110 of the embodiment in FIG. 9. In one embodiment, the implementation in FIG. 9 may form a partial layout of the system 15 in FIGS. 1 and 11. As shown in FIG. 9, the processor 20 may include one or more processor cores 26 and a CGFS unit 112. The discussion herein applies regardless of whether the processor 20 has a single core on its die or multiple cores. As noted earlier, for the sake of convenience and ease of discussion, the reference numeral “26” is used to interchangeably refer to a processor core and the semiconductor die containing the core. However, it is understood that, in one embodiment, the die may contain more than one core and/or other non-core elements such as, for example, the CGFS unit 112. In another embodiment, multiple cores may be formed on multiple dies. For the clarity of discussion, the CGFS unit in FIG. 9 is identified using a different reference numeral to distinguish it from the processor core(s), even though the cores and the CGFS unit all may be part of the same die.

In one embodiment, the CGFS unit 112 may be a clock generator in the processor 20 that is suitably modified in hardware and/or software to perform the frequency staggering such as, for example, as per the methodology of the embodiment in FIG. 6. The CGFS unit 112 may provide clock signals to all the processor cores on the die. The operating system (OS) or other software (SW) 114 (e.g., an application-specific software) sending instructions for execution by processor core(s) 26 may have the ability to make a prediction of droop events based on the flow of instruction execution. The communication between the OS/SW block 114 and the processor 20 is indicated using the bi-directional arrow 115. A “droop event” may refer to a switching activity that, when performed by the logic circuits (not shown) in the processor core(s) 26, may be capable of causing a first droop in the voltage being delivered to the core(s). In case of a multi-core processor, more than one process core may be utilized in performing the switching activity. These predictable droop events for a core 26 include events such as, for example, a sleep state transition, a performance state transition, a scheduled heavy computation including vector and graphics processing, and resets to a processing state or operating condition.

In one embodiment, the software 114 may be able to indicate such droop events to the processor-based clock generation hardware 112 using a droop event anticipation signal 116 whenever the software anticipates a droop event. This action is indicated at block 122 in FIG. 10. In one embodiment, such droop event signal 116 may be in the form of a trigger bitz—for example, a logic “1” or “high” value of the trigger bit indicating a presence of a droop event, whereas a logic “0” or “low” value of the trigger bit indicating an absence of a droop event. As noted before, the CGFS unit 112 may be equipped with frequency staggering capability—through its configuration in hardware and/or software (or microcode). Thus, in response to the signal at block 122, the CGFS unit 112 may drop the current operating frequency of the core(s) 26 to a pre-determined, base value that is considered safe (or more preferable) for the droop event (block 124). In one embodiment, the base frequency may be the frequency “f₁” shown in FIG. 7. If the processor 20 is a multi-core processor, in one embodiment, the CGFS unit 112 may reduce the clock frequency to the base value for each of the processor cores. A sufficient time later, the CGFS unit 112 may ramp up the frequency in multiple steps to reach the target value for the steady state operation of the core(s) (block 126). In one embodiment, such “target” frequency may be the frequency “fₘₐₓ” shown in FIG. 7. The time delays between each frequency increase may be similar to the delays “D1” and “D2” illustrated in the exemplary embodiment of FIG. 7. After the core clock frequency reaches its target value in steady state, the CGFS unit 112 may re-establish the frequency lock for consistent and uninterrupted clocking of the processor core(s) 26, as noted at block 128 in FIG. 10.

Thus, the frequency staggering approach illustrated in FIGS. 9-10 is primarily a low cost, software-based solution that may not require too much additional hardware, and can be used for first droop mitigation in power delivery to a processor core.

FIG. 11 depicts a more detailed layout of the system 15 in FIG. 1 according to one embodiment of the present disclosure. In one embodiment, the processor 20 in FIG. 11 may have the architectural configuration shown in FIG. 9. Thus, the frequency staggering-based first droop mitigation approach discussed hereinbefore may be implemented in the processor 20 in FIG. 11.

In FIG. 11, the processor 20 is shown coupled to a system memory unit 130 as well as to a peripheral storage unit 132, one or more input devices 134, one or more output devices 136, and a network interface unit 138. In some embodiments, the system 15 may include more than one instance of the devices or units shown. Furthermore, it is understood that the units shown as part of the system 15 in FIG. 11 may themselves contain may other complex components. However, such components are not illustrated in FIG. 11 because of their lack of relevance to the present disclosure. Also, in certain embodiments, the system 15 may include more units or less units than those shown in FIG. 11. As mentioned earlier, some examples of the system 15 include a computer system (desktop or laptop), a tablet computer, a mobile device, a cellular phone or User Equipment (UE), a video gaming unit or console, a machine-to-machine (M2M) communication unit, a stateless “thin” client system, or any other type of computing or data processing device. In various embodiments, the system 15 may be configured as a rack-mountable server system, a standalone system, or in any other suitable form factor. In some embodiments, the system 15 may be configured as a client system rather than a server system.

In particular embodiments, the processor 20 may include more than one CPUs, and/or the system 15 may include more than one processors 20 (e.g., in a distributed processing configuration). When the system 15 is a multiprocessor system, there may be more than one instance of a CPU or processor. The processor 20 may be a System on Chip (SoC), a server processor, or an Application Processor (AP) having functionality in addition to a CPU functionality. As mentioned earlier, the processor 20 may be, for example, a CPU, a microprocessor, an ALU, a GPU, a memory controller, a peripheral interface controller such as a Peripheral Component Interconnect Express (PCIe) root complex or switch, or any other processing device. It is understood that, instead of or in addition to the CPU, the processor 20 may contain any other type of processors such as, for example, a general purpose processor, a special purpose processor, a conventional processor, a microcontroller, a Digital Signal Processor (DSP), a plurality of microprocessors, one or more microprocessors in association with a DSP core, a dedicated Application Specific Integrated Circuit (ASIC) processor, Field Programmable Gate Array (FPGA) circuits, a state machine, and the like. Furthermore, in one embodiment, the processor/host 20 may include more than one CPU, which may be operative in a distributed processing environment. The processor 20 may be configured to execute instructions and to process data according to a particular Instruction Set Architecture (ISA) such as, for example, an ×86 instruction set architecture (32-bit or 64-bit versions), a PowerPC® ISA, or a MIPS (Microprocessor without Interlocked Pipeline Stages) instruction set architecture relying on RISC (Reduced Instruction Set Computer) ISA.

The memory unit 130 may include at least one memory module, which may be any semiconductor-based storage system such as, for example, Dynamic Random Access Memory (DRAM), Static Random Access Memory (SRAM), Phase-Change Random Access Memory (PRAM or PCRAM), Resistive Random Access Memory (RRAM or ReRAM), Conductive-Bridging RAM (CBRAM), Magnetic RAM (MRAM), Spin-Transfer Torque MRAM (STT-MRAM), and the like. In some embodiments, the memory unit 130 may include at least one Three Dimensional Stack (3DS) memory module with or without one or more non-3DS memory modules. The non-3DS memory may include Double Data Rate (DDR) memory, DDR 2, 3, or 4 (DDR2/DDR3/DDR4) memories, Synchronous DRAM (SDRAM), Rambus® DRAM, flash memory, various types of Read Only Memory (ROM), etc. Also, in some embodiments, the system memory 130 may include multiple different types of semiconductor memories, as opposed to a single type of memory.

The peripheral storage unit 132, in various embodiments, may include support for magnetic, optical, magneto-optical, or solid-state storage media such as hard drives, Solid State Drives (SSDs), optical disks (such as CDs or DVDs), non-volatile RAM devices, etc. In some embodiments, the peripheral storage unit 132 may include more complex storage devices/systems such as disk arrays (which may be in a suitable RAID (Redundant Array of Independent Disks) configuration) or Storage Area Networks (SANs), which may be coupled to the processor 20 via a standard Small Computer System Interface (SCSI), a Fibre Channel interface, a Firewire® (IEEE 1394) interface, or another suitable interface. In one embodiment, the peripheral storage unit 132 may be coupled to the processor 20 via a standard peripheral interface such as, for example, the Peripheral Component Interface Express (PCI Express™) standard based interface, the Universal Serial Bus (USB) protocol based interface, or the IEEE 1394 (Firewire®) protocol based interface.

In one embodiment, the program code for the OS or other application software 114 may reside in the system memory 130 and executed by the processor 20. In another embodiment, such program code may be stored in the peripheral storage unit 132 and executed by the processor 20.

In particular embodiments, the input devices 134 may include standard input devices such as a computer keyboard, mouse or other pointing device, a touchpad, a touch-screen, a joystick, or any other type of data input device. The output devices 136 may include a graphics/display device, a computer screen, a UE screen, an audio speaker, an alarm system, a CAD/CAM (Computer Aided Design/Computer Aided Machining) system, a video game station, or any other type of data output or process control device. In some embodiments, the input device(s) 134 and the output device(s) 136 may be coupled to the host processor 20 via an I/O or peripheral interface(s).

In one embodiment, the network interface 138 may communicate with the host processor 20 to enable the system 15 to couple to a network (not shown). In another embodiment, the network interface 138 may be absent altogether. The network interface 138 may include any suitable devices, media and/or protocol content for connecting the system 15 to a network—whether wired or wireless. In various embodiments, the network may include Local Area Networks (LANs), Wide Area Networks (WANs), wired or wireless Ethernet, telecommunication networks, the Internet, or other suitable types of networks.

The system 15 may include an on-board power supply unit 140 to provide electrical power to various system components illustrated in FIG. 11. The power supply unit 140 may receive batteries or may be connectable to an AC electrical power outlet. In one embodiment, the power supply unit 140 may convert solar energy into electrical power.

In the preceding description, for purposes of explanation and not limitation, specific details are set forth (such as particular architectures, interfaces, techniques, etc.) in order to provide a thorough understanding of the disclosed technology. However, it will be apparent to those skilled in the art that the disclosed technology may be practiced in other embodiments that depart from these specific details. That is, those skilled in the art will be able to devise various arrangements which, although not explicitly described or shown herein, embody the principles of the disclosed technology. In some instances, detailed descriptions of well-known devices, circuits, and methods are omitted so as not to obscure the description of the disclosed technology with unnecessary detail. All statements herein reciting principles, aspects, and embodiments of the disclosed technology, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

Thus, for example, it will be appreciated by those skilled in the art that block diagrams herein, such as, for example, in FIGS. 1, 9, and 11, can represent conceptual views of illustrative circuitry or other functional units embodying the principles of the technology. Similarly, it will be appreciated that the flow charts herein, such as, for example, in FIGS. 6 and 10 may represent various processes or innovative aspects which may be substantially performed by a suitably-configured clock generator such as, for example, the CGFS unit 112 in FIG. 9.

When certain inventive aspects require software-based processing, such software or program code may reside in a computer-readable data storage medium (not shown). Such data storage medium may be part of the peripheral storage 132 in the embodiment of FIG. 11. The processor 20 may execute relevant instructions stored on such a medium to carry out the software-based processing. The computer-readable data storage medium may be a non-transitory data storage medium containing a computer program, software, firmware, or microcode for execution by a general purpose computer or a processor mentioned above. Examples of computer-readable storage media include a Read Only Memory (ROM), a Random Access Memory (RAM), a digital register, a cache memory, semiconductor memory devices, magnetic media such as internal hard disks, magnetic tapes and removable disks, magneto-optical media, and optical media such as CD-ROM disks and Digital Versatile Disks (DVDs).

Alternative embodiments of the first droop mitigation methodology according to inventive aspects of the present disclosure may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features. As mentioned before, the functions of some of the elements in the system 15—such as, for example, the CGFS unit 112 in the processor 20—may be provided through the use of hardware (such as logic circuits) and/or hardware capable of executing software/firmware in the form of coded instructions or microcode stored on a computer-readable data storage medium (mentioned above). Thus, such functions and illustrated functional blocks are to be understood as being either hardware-implemented and/or computer-implemented, and thus machine-implemented.

The foregoing describes a first droop mitigation methodology in which the clock frequency applied to a processor's core is reduced from its normal operating value when a droop event capable of causing the first droop in the voltage being delivered to the core is anticipated. The reduced core switching frequency reduces the average core current injected into the power delivery network associated with the core, thereby mitigating the first droop. The reduced frequency is then gradually increased back to its normal operating value through a multi-step frequency ramp, instead of one fixed step. A pre-determined delay may be applied prior to each frequency increase step. A clock generator in the processor die may be configured to perform such frequency staggering in response to a droop event signal, which may be generated by the operating system or other program code being executed by the processor. The first droop mitigation approach as described herein may be predominantly software-based, and can be applied to core power delivery.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method comprising:
receiving a droop event signal at a processor, wherein the droop event signal anticipates a switching activity that is to be performed by a core logic in the processor and that is capable of causing a first droop in voltage being delivered to the core logic;
in response to the droop event signal, reducing frequency of a clock signal being supplied to the core logic to a first frequency value; and
gradually increasing the frequency of the clock signal from the first frequency value to a final frequency value through multiple steps.

2. The method of claim 1, wherein the final frequency value is the frequency of the clock signal prior to reception of the droop event signal.

3. The method of claim 1, wherein the first frequency value is pre-determined.

4. The method of claim 1, wherein gradually increasing the frequency of the clock signal includes:
increasing the frequency of the clock signal from the first frequency value to the final frequency value using a pre-determined time delay prior to each frequency increase step.

5. The method of claim 4, wherein the pre-determined time delay is greater than the time-wise duration of the first droop.

6. The method of claim 1, wherein gradually increasing the frequency of the clock signal includes:
increasing the frequency of the clock signal from the first frequency value to a second frequency value after a first time delay has elapsed since application of the first frequency value to the core logic; and
increasing the frequency of the clock signal from the second frequency value to the final frequency value after a second delay has elapsed since application of the second frequency value to the core logic.

7. The method of claim 6, wherein the first and the second time delays are equal.

8. The method of claim 1, wherein the first frequency value is less than half of the final frequency value.

9. A processor comprising:
a core logic to process a program code; and
a clock generator to supply a clock signal to the core logic, wherein the clock generator is operative to:
receive a droop event signal from the program code, wherein the droop event signal anticipates a switching activity that is to be performed by the core logic and that is capable of causing a first droop in voltage being delivered to the core logic,
reduce frequency of the clock signal to a first frequency value in response to the droop event signal, and
gradually increase the frequency of the clock signal from the first frequency value to a final frequency value through multiple steps.

10. The processor of claim 9, wherein the final frequency value is the frequency of the clock signal immediately prior to reduction to the first frequency value.

11. The processor of claim 9, wherein the first frequency value is pre-determined.

12. The processor of claim 11, wherein the first frequency value is less than half of the final frequency value.

13. The processor of claim 9, wherein the clock generator is operative to perform the following as part of gradually increasing the frequency of the clock signal:
increase the frequency of the clock signal from the first frequency value to the final frequency value using a pre-determined time delay prior to each frequency increase step.

14. The processor of claim 9, wherein the clock generator is operative to perform the following as part of gradually increasing the frequency of the clock signal:
increase the frequency of the clock signal from the first frequency value to a second frequency value after a first time delay has elapsed since application of the first frequency value to the core logic; and
increase the frequency of the clock signal from the second frequency value to the final frequency value after a second delay has elapsed since application of the second frequency value to the core logic.

15. The processor of claim 14, wherein the first and the second time delays are equal.

16. A system comprising:
a power supply unit; and
a processor coupled to the power supply unit, wherein the processor includes:
a core logic to process a program code; and
a clock generator to supply a clock signal to the core logic, wherein the clock generator is operative to:
receive a droop event signal from the program code, wherein the droop event signal anticipates a switching activity that is to be performed by the core logic and that is capable of causing a first droop in voltage being delivered to the core logic by the power supply unit,
reduce frequency of the clock signal to a first frequency value in response to the droop event signal, and
gradually increase the frequency of the clock signal from the first frequency value to a final frequency value through multiple steps.

17. The system of claim 16, further comprising:
a memory unit coupled to the processor and configured to store the program code.

18. The system of claim 16, wherein the first frequency value is pre-determined.

19. The system of claim 16, wherein the clock generator is operative to perform the following as part of gradually increasing the frequency of the clock signal:
increase the frequency of the clock signal from the first frequency value to the final frequency value using a pre-determined time delay prior to each frequency increase step.

20. The system of claim 19, wherein the clock generator is operative to further perform the following as part of gradually increasing the frequency of the clock signal:
increase the frequency of the clock signal from the first frequency value to a second frequency value after the pre-determined time delay has elapsed since application of the first frequency value to the core logic; and
increase the frequency of the clock signal from the second frequency value to the final frequency value after the pre-determined time delay has elapsed since application of the second frequency value to the core logic.
